(19) United States
(12) Patent Application Publication
(10) Pub. No.: US 2009/0302078 A1
(43) Pub. Date: Dec. 10, 2009

(54) BICYCLE RACK

(76) Inventor: CHIU-KUEI WANG, Dajia Town (TW)

Correspondence Address: PHILLIP LIU, 6980, WHITEOAK DRIVE, RICHMOND, V7E4Z9, omitted

(21) Appl. No.: 12/238,267

(22) Filed: Sep. 25, 2008

(30) Foreign Application Priority Data
Oct. 2, 2007 (TW) 096216449

(51) Int. Cl. B60R 9/10

(52) U.S. Cl. 224/502; 224/532

(57) ABSTRACT

A bicycle rack includes a carry portion having a U-shaped frame and multiple positioning members are connected on the U-shaped frame so as to position bicycles. A Y-shaped support portion includes a post whose top end is connected to two support rods by a clamp unit and the clamp unit includes two slots with which the two supports are securely engaged. The U-shaped frame is connected to the two support rods. A connection portion includes an L-shaped tube which has a first end pivotably connected to a lower end of the post and a second end of the L-shaped tube is connected to a vehicle.

### FIELD OF THE INVENTION

The present invention relates to a bicycle rack connected to a vehicle, and more particularly, to a bicycle rack with Y-shaped support portion to provide sufficient support to bicycles on the bicycle rack.

### BACKGROUND OF THE INVENTION

A conventional bicycle rack 7 is shown in FIG. 8 and connected to back of a vehicle so as to carry bicycles to destinations by vehicles. The conventional bicycle rack 7 generally includes an L-shaped post 72 which has a support member 71 connected to the horizontal section of the L-shaped post 72. The support member 71 includes multiple positioning spots to which the bicycles are positioned. A connection member 73 is connected between the distal end of the vertical section of the L-shaped post 72 and the hitch of a vehicle (both not shown). It is noted that the bicycles are carried on the horizontal section of the L-shaped post 72 and shake during transportation. There is only one short and linear horizontal section to carry the bicycles and each bicycle is only positioned at a single point, so that the support to the bicycles is obviously not sufficient and the shaking and vibration might be dangerous to the vehicle.

The present invention intends to provide a bicycle rack which is easily connected to the hitch of vehicle and includes a Y-shaped support portion to provide multiple support points to each bicycle carried on the bicycle rack.

### SUMMARY OF THE INVENTION

The present invention relates to a bicycle rack that comprises a carry portion, a Y-shaped support portion and a connection portion, wherein the carry portion includes a U-shaped frame on which multiple positioning members are connected. The Y-shaped support portion includes a post, two support rods and a clamp unit, wherein the clamp unit is connected to a top end of the post and includes two slots with which the two supports are securely engaged. The U-shaped frame is connected to the two support rods. The connection portion includes an L-shaped tube which has a first end pivotably connected to a lower end of the post and a second end of the L-shaped tube 31 is connected to a vehicle.

The primary object of the present invention is to provide a bicycle rack with a Y-shaped support portion which secures the bicycles in stable status and the support portion can be pivoted relative to the connection portion for convenience of open of back hatch of the vehicle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the bicycle rack of the present invention;

FIG. 2 is a perspective view to show the bicycle rack of the present invention;

FIG. 3 is a side view to show the bicycle rack of the present invention;

FIG. 4 is a cross sectional view taken along line a-a in FIG. 3;

FIG. 5 shows the bicycle rack of the present invention is connected to a vehicle and the support portion is pivotable relative to the connection portion of the bicycle rack;

FIG. 6 is a cross sectional view taken along line b-b in FIG. 5 when the grip is on the connection portion;

FIG. 7 is a cross sectional view taken along line b-b in FIG. 5 when the grip is not on the connection portion, and

FIG. 8 shows a conventional bicycle rack.

### DETAILED DESCRIPTION OF THE PREFERRED EMBODIMENT

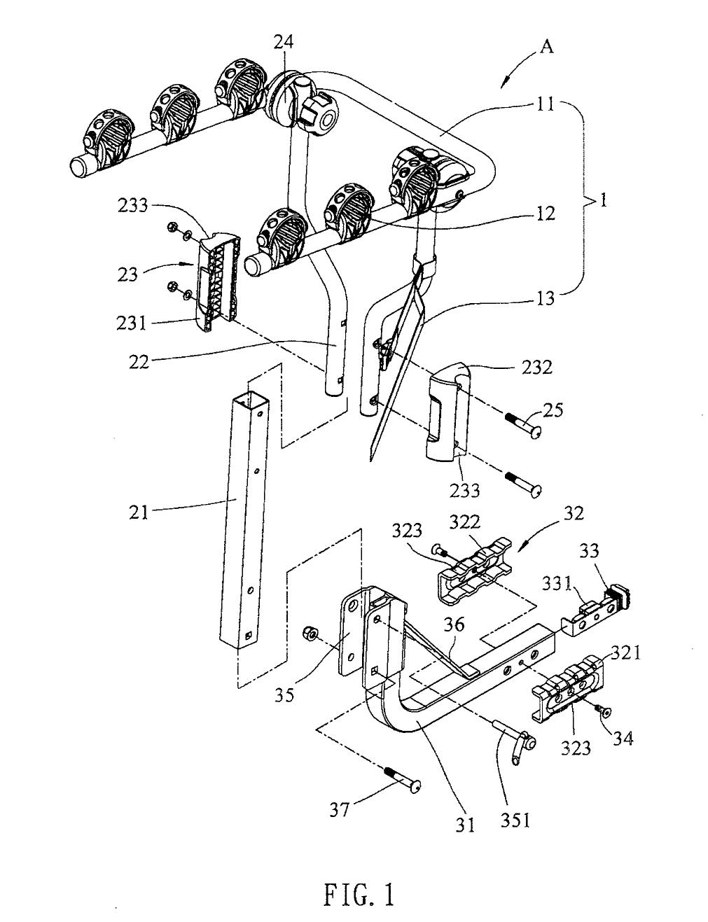

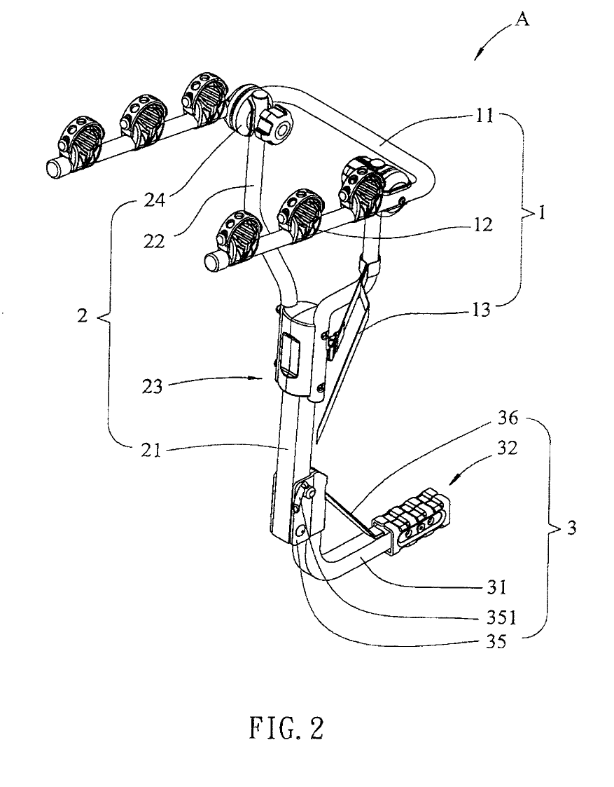

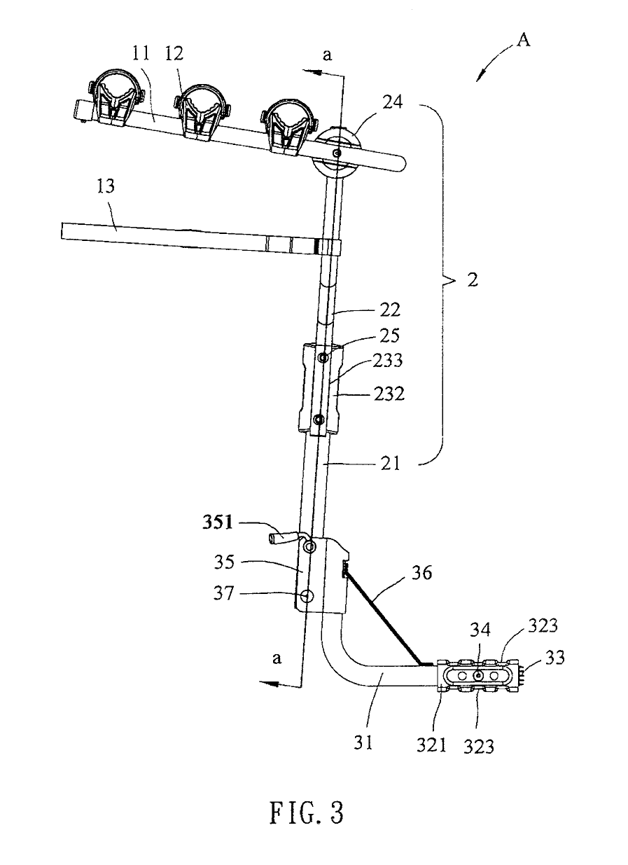

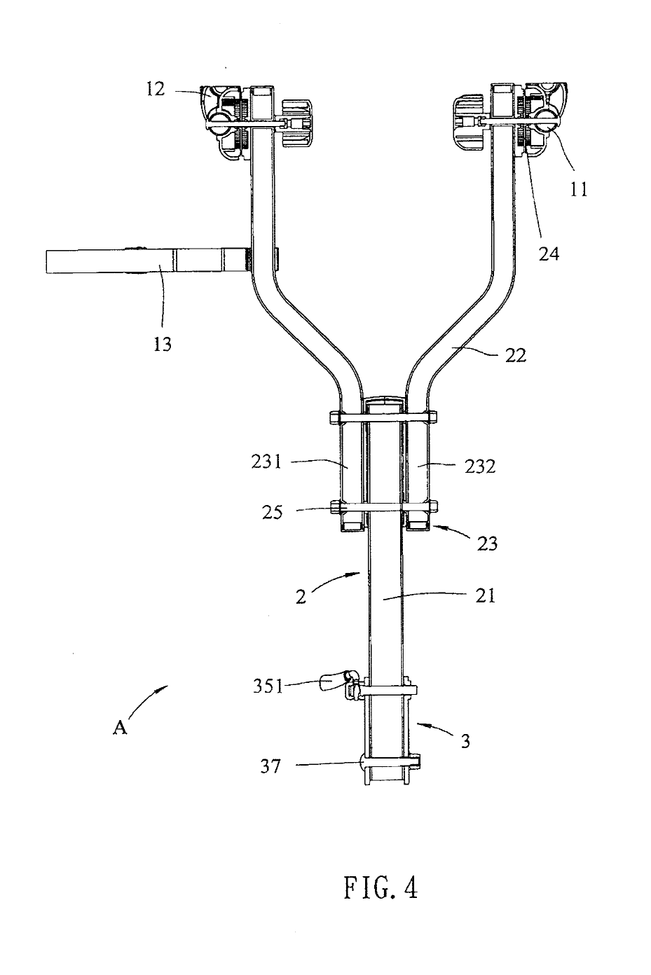

Referring to FIGS. 1 to 4, the bicycle rack “A” of the present invention comprises a carry portion 1, a Y-shaped support portion 2 and a connection portion 3. The carry portion includes a U-shaped frame 11 and multiple positioning members 12 are connected on the U-shaped frame 11.

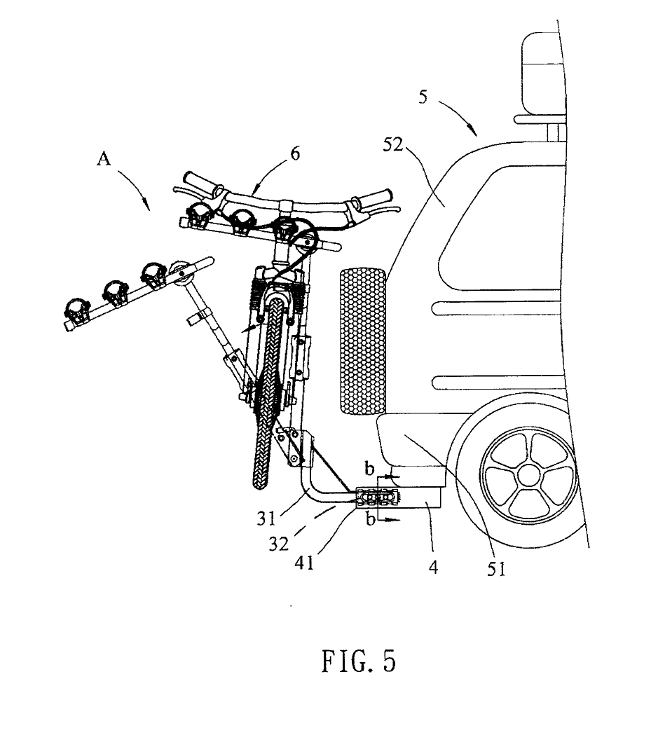

The Y-shaped support portion 2 includes a post 21, two support rods 22 and a clamp unit 23. The clamp unit 23 is composed of a first part 231 and a second part 232, and the top end of the post 21 is clamped between the first and second parts 231, 232 by bolts 25 cooperated with nuts. The clamp unit 23 includes two slots 233 with which the two support rods 22 are securely engaged by the bolts 25. The two support rods 22 are located at a distance and the U-shaped frame 11 is connected to the two support rods 22 by two angle adjustable members 24 such that the U-shaped frame 11 can be adjusted the angle relative to the two support rods 22. A strap 13 is connected to one of the two support rods 22 to further tie the bicycles 6 (FIG. 5) positioned on the positioning members 12.

The connection portion 3 includes an L-shaped tube 31 which has a first end pivotably connected to a lower end of the post 21 and a second end of the L-shaped tube 31 is connected to a hitch 4 located beneath the bump 51 of a vehicle 5. The connection portion 3 includes a grip 32 which is connected to the second end of the L-shaped tube 31. The grip 32 is composed of a first piece 321 and a second piece 322, each of the first and second pieces 321, 322 have the grooves 323 defined in an outer surface thereof. The second end of the L-shaped tube 31 is securely clamped between the first and second pieces 321, 322 by bolts 34. An insertion 33 is removably inserted into the opening of the second end of the L-shaped tube 31 and nuts 331 are received in the insertion 33 such that the bolts 34 are firmly connect the first and second pieces 321, 322 to the second end of the L-shaped tube 31. A reinforcement plate 36 is connected between the first and second ends of the L-shaped tube 31 to reinforce the structural strength thereof. Two connection plates 35 are connected to the first end of the L-shaped tube 31 and the lower end of the post 21 is pivotably connected between the two connection plates 34 by a bolt 37 and a quick-release device 351 at two different positions.

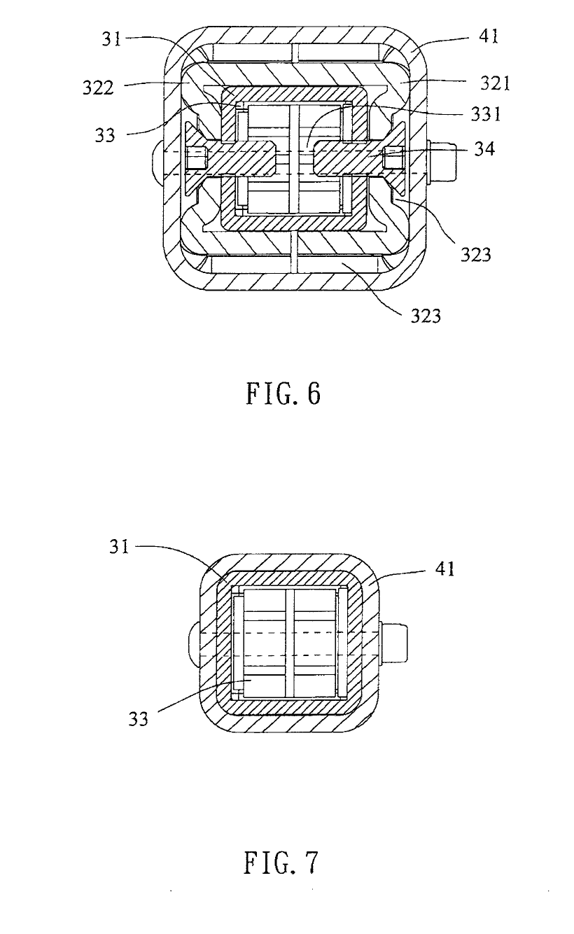

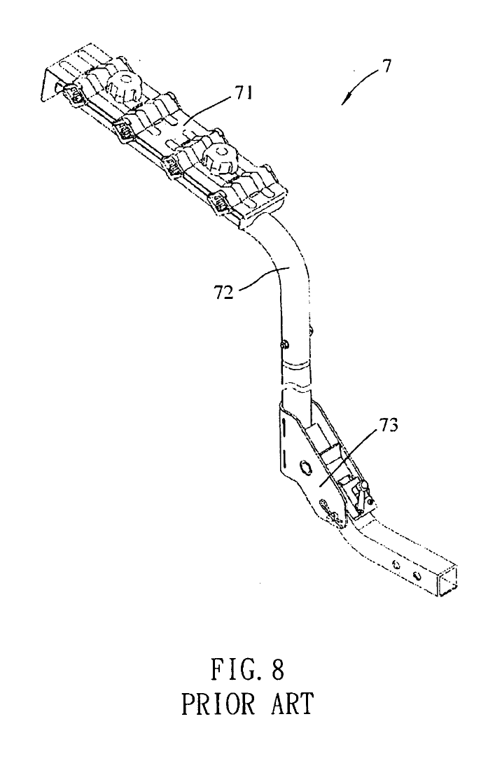

As shown in FIG. 6, if the hole 41 of the hitch 4 is a big hole, the grip 32 and the second end of the L-shaped tube 31 can be inserted into the hole 41 by griping the grip 32 and push the grip 32 into the hole 41. If the hole 41 of the hitch 4 is a small hole, the grip 32 can be removed from the second end of the L-shaped tube 31 and only the second end of the L-shaped tube 31 is inserted into the hole 41 as shown in FIG. 7.

Referring to FIG. 5, the carry portion and the support portion 2 can be pivoted relative to the connection portion 3 by releasing the quick-release device 351 so that the back hatch 52 of the vehicle 5 can be opened.

The U-shaped frame 11 and the support rods 22 may have circular or rectangular cross section as desired and each bicycle 2 can be fixed by two positioning members 12 at a distance so that the bicycles 6 are secured and stable. The grip 32 can be removed from the L-shaped connection tube 31 depending on the size of the hole 41 of the hitch 4 on the vehicle 5.

While we have shown and described the embodiment in accordance with the present invention, it should be clear to those skilled in the art that further embodiments may be made without departing from the scope of the present invention.

What is claimed is:

1. A bicycle rack comprising:
a carry portion having a U-shaped frame and multiple positioning members on the U-shaped frame;
a Y-shaped support portion having a post, two support rods and a clamp unit, the clamp unit connected to a top end of the post and including two slots with which the two support rods are securely engaged, the U-shaped frame connected to the two support rods, and
a connection portion including an L-shaped tube which has a first end pivotably connected to a lower end of the post and a second end of the L-shaped tube adapted to be connected to a vehicle.

2. The bicycle rack as claimed in claim 1, wherein the connection portion includes a grip which is connected to the second end of the L-shaped tube, the grip includes multiple grooves defined in an outer surface thereof.

3. The bicycle rack as claimed in claim 2, wherein the grip is composed of a first piece and a second piece, each of the first and second pieces have the grooves, the second end of the L-shaped tube is securely clamped between the first and second pieces by bolts.

4. The bicycle rack as claimed in claim 2, wherein a reinforcement plate is connected between the first and second ends of the L-shaped tube.

5. The bicycle rack as claimed in claim 2, wherein the connection portion includes two connection plates on the first end of the L-shaped tube, the lower end of the post is pivotably connected between the two connection plates.

6. The bicycle rack as claimed in claim 5, wherein the lower end of the post is pivotably connected between the two connection plates by a bolt and a quick-release device.

7. The bicycle rack as claimed in claim 1, wherein the clamp unit is composed of a first part and a second part, the top end of the post is clamped between the first and second parts by bolts.
